(19) United States
(12) Patent Application Publication
(10) Pub. No.: US 2011/0123773 A1
(43) Pub. Date: May 26, 2011

(54) METHOD AND DEVICE FOR PRODUCING A MULTI-PLY FIBROUS PRODUCT AND MULTI-PLY FIBROUS PRODUCT

(75) Inventors: Bernd Lofink, Dirmstein (DE); Harald Harlacher, Mannheim (DE); Jurgen Sauter, Mannheim (DE); Richard Kiehlmann, Sandhausen (DE)

(73) Assignee: SCA HYGIENE PRODUCTS AB, Goteborg (SE)

(21) Appl. No.: 13/055,719

(22) PCT Filed: Jul. 25, 2008
(86) PCT No.: PCT/EP2008/059795

§ 371 Date: Jan. 25, 2011

(51) Int. Cl. B32B 3/30; B32B 38/06

(52) U.S. Cl. 428/166; 156/219; 156/582

(57) ABSTRACT

A device for producing a multi-ply fibrous product includes an embossing roll with first and second embossing protrusions on its outer circumferential surface having at least two different heights in a radial direction, an anvil roll cooperating with the embossing roll, an application roll for applying colored adhesive or ink arranged next to the embossing roll, and a marrying roll or another embossing roll running against the embossing roll, wherein the application roll forms a negative gap with the outer diameter of the embossing roll, and the negative gap exceeds the difference in height of the first and second protrusions. A method for producing a multi-ply fibrous product and a multi-ply fibrous product are also described.

### FIELD OF THE INVENTION

The invention relates to a method for producing a multi-ply fibrous product, especially a tissue paper product, non-woven product or a hybrid thereof and preferably a hygiene or cleaning product. Further, the invention relates to a device for producing such a multi-ply fibrous product and a multi-ply fibrous product.

### BACKGROUND OF THE INVENTION AND PRIOR ART

Hygiene or wiping products primarily include all kinds of dry-creped tissue paper, wet-creped paper, TAD-paper (Through Air Drying) and cellulose or pulp-wadding or all kinds of non-wovens, or combinations, laminates or mixtures thereof. Typical properties of these hygiene and wiping products include the reliability to absorb tensile stress energy, their drapability, good textile-like flexibility, properties which are frequently referred to as bulk softness, a higher surface softness and a high specific volume with a perceptible thickness. A liquid absorbency as high as possible and, depending on the application, a suitable wet and dry strength as well as an appealable visual appearance of the outer product's surface are desired. These properties, among others, allow these hygiene and wiping products to be used, for example, as cleaning wipes such as paper or non-woven wipes, windscreen cleaning wipes, industrial wipes, kitchen paper or the like; as sanitary products such as for example bathroom tissue, paper or non-woven handkerchiefs, household towels, towels and the like; as cosmetic wipes such as for example facials and as serviettes or napkins, just to mention some of the products that can be used. Furthermore, the hygiene and wiping products can be dry, moist, wet, printed or pretreated in any manner. In addition, the hygiene and wiping products may be folded, interleaved or individually placed, stacked or rolled, connected or not, in any suitable manner.

Due to the above description, the products can be used for personal and household use as well as commercial and industrial use. They are adapted to absorb fluids, remove dust, for decorative purposes, for wrapping or even just as supporting material, as is common for example in medical practices or in hospitals.

If tissue paper is to be made out of pulp, the process essentially comprises a forming that includes a box and a forming wire portion, and a drying portion (either through air drying or conventional drying on a yankee cylinder). The production process also usually includes the crepe process essential for tissues and, finally, typically a monitoring and winding area.

Paper can be formed by placing the fibers, in an oriented or random manner, on one or between two continuously revolving wires of a paper making machine while simultaneously removing the main quantity of water of dilution until dry-solids contents of usually between 12 and 35% are obtained.

Drying the formed primary fibrous web occurs in one or more steps by mechanical and thermal means until a final dry-solids content of usually about 93 to 97% has been reached. In case of tissue making, this stage is followed by the crepe process which crucially influences the properties of the finished tissue product in conventional processes. The conventional dry crepe process involves creping on a usually 4.0 to 6.5 m diameter drying cylinder, the so-called yankee cylinder, by means of a crepe doctor with the aforementioned final dry-solids content of the raw tissue paper. Wet creping can be used as well, if lower demands are made of the tissue quality. The creped, finally dry raw tissue paper, the so-called base tissue, is then available for further processing into the paper product for a tissue paper product.

Instead of the conventional tissue making process described above, the use of a modified technique is possible in which an improvement in specific volume is achieved by a special kind of drying which leads to an improvement in the bulk softness of the tissue paper. This process, which exists in a variety of subtypes, is termed the TAD (Through Air Drying) technique. It is characterized by the fact that the “primary” fibrous web that leaves the forming and sheet making stage is pre-dried to a dry-solids content of about 80% before final contact drying on the yankee cylinder by blowing hot air through the fibrous web. The fibrous web is supported by an air-permeable wire or belt or TAD-fabric and during its transport is guided over the surface of an air-permeable rotating cylinder drum, the so-called TAD-cylinder. Structuring the supporting wire or belt makes it possible to produce any pattern of compressed zones broken up by deformation in the moist state, also named moulding, resulting in increased mean specific volumes and consequently leading to an increase of bulk softness without decisively decreasing the strength of the fibrous web.

To produce multi-ply tissue paper products, such as handkerchiefs, bathroom paper, towels or household towels, an intermediate step often occurs with so-called doubling in which the base tissue in the desired number of plies is usually gathered on a common multi-ply mother reel.

The processing step from the base tissue that has already been optionally wound up in several plies to the finished tissue product occurs in processing machines (converting machines) which include operations such as unwinding the base tissue, repeated smoothing of the tissue, printing, embossing, to an extent combined with full area and/or local application of adhesive to produce ply adhesion of the individual plies to be combined together as well as longitudinal cut, folding, cross cut, placement and bringing together a plurality of individual tissues and their packaging as well as bringing them together to form larger surrounding packaging or bundles. Such processing steps may also include application of substances like scents, lotions, softeners or other chemical additives. The individual paper ply webs can also be pre-embossed and then combined in a roll gap according to the embossing methods known in the art. Any embossing can lead to embossed elements all having the same height or to embossing elements having different heights. Ply bonding, e.g. by mechanical or by chemical means are other well-known methods mainly used for hankies, napkins and bathroom tissues.

A well-known technique to increase the thickness of a paper product is to emboss the paper web. An embossing process is carried out in the nip between an embossing roll and an anvil roll. The embossing roll can have protrusions on its circumferential surface leading to so-called embossed depressions in the paper web or it can have depressions in its circumferential surface leading to so-called embossed protrusions in the paper web.

Anvil rolls may be softer than the corresponding embossing roll and may consist of rubber, such as natural rubber, or anvil rolls are made of plastic materials, paper or steel.

For manufacturing multi-ply tissue products, especially bathroom tissue and household tissue, three main manufacturing methods for embossing and adhesively bonding of the plies have established. These are Goffra Incolla/spot embossing, DESL (Double Embossing Single Lamination)/Nested, and Pin-to-Pin/Foot-to-Foot.

In the first mentioned manufacturing method, Goffra Incolla, a first web formed by the top ply or top plies is directed through the nip between an embossing roll and an anvil roll. In this nip the web is provided with an embossing pattern. Thereafter, an application roll for adhesive applies adhesive to those parts of the first web at which there are protruding embossing elements in the embossing roll. The adhesive is transported from an adhesive bath via an adhesive transfer roll to the application roll. A second web forming the bottom ply or plies is transported to the first web and adhesively bonded to the first web in the nip between the so-called marrying roll and the embossing roll. The adhesive bonding takes place at those portions at which the adhesive was applied.

The second manufacturing method (DESL/Nested) is very similar to the above-described Goffra Incolla method. It comprises an additional pair of rolls consisting of a second embossing roll and a second anvil roll. The additional pair of rolls serves to emboss the second web before it is adhesively bonded to the first web using the marrying roll. Typically, the additional pair of rolls is placed close to the first pair of rolls and the marrying roll. Especially when using the so-called Nested-method such close arrangement is important. The Nested-method can be considered as a special case of the general DESL-manufacturing method. For the Nested-method the embossing elements of the first embossing roll and the embossing elements of the second embossing roll are arranged such that the embossed elements of the first embossed ply or plies and the embossed elements of the second embossed ply or plies fit into each other similar to a gearing system. This serves to achieve a mutual stabilization of the plies. However, for the DESL manufacturing method such correlation between the embossed elements of the first, upper ply or plies and the second, lower ply or plies, does not have to apply. Nevertheless, in the literature the term DESL is often used synonymous to a Nested-method.

The third manufacturing method (Pin-to-Pin/Foot-to-Foot) is similar to the DESL method. By means of two pairs of rolls both the upper ply or plies and the lower ply or plies are embossed, respectively. Adhesive is applied onto the embossed protrusions of the first ply or plies. The ply bonding however, is not achieved by means of a marrying roll as in the DESL method but is achieved directly by means of the protruding embossing elements of the second embossing roll. In order to achieve this, an exact adjustment of the width of the nip between the first embossing roll and the second embossing roll is required, which is mainly defined by the individual thickness of both webs (upper ply or plies and lower ply or plies). Further, the embossing rolls have to be designed such that the protruding embossing elements of both rolls face each other. This is the reason why the terminology Pin-to-Pin or Foot-to-Foot embossing is used.

All above described methods have the following common features: the first embossing roll is formed of a hard material, usually metal, especially steel, but there are also known embossing rolls made of hard rubber or hard plastics materials. The embossing rolls can be a male roll having individual protrusions. Alternatively, the embossing roll can be a female roll with individual embossing depressions. Typical depths of the engraved embossing patterns are between 0.4 and 2.0 mm.

The anvil roll typically has a rubber coating with a hardness between 35 Shore A and 85 Shore A. However, structurized anvil rolls, especially rolls made of paper, rubber or plastics materials or steel are also known. Often used is EPMD as an elastic material.

The applicator roll for adhesive is usually also a rubber roll usually having a plain smooth circumferential surface, wherein the hardness of the rubber coating is between the hardness of the anvil roll and the hardness of the marrying roll. Structurized applicator rolls are also known. Commonly used values for the hardness of the rubber coating are 80 to 85 Shore A. When selecting the rubber material its compatibility with the adhesive to be applied has to be ensured. For tissue converting, usually NBR is used.

The application system for adhesive consisting of applicator roll, adhesive transfer roll and adhesive bath can be designed as a so-called immersion roll system in which the adhesive transfer roll is immersed into the adhesive bath and transports adhesive by means of surface tension and adhesive forces out of the adhesive bath. By adjusting the gap between the adhesive transfer roll and the applicator or application roll, the amount of adhesive to be applied can be adjusted. Usually, there is a small negative gap of around 0.05 to 0.4 mm between the adhesive applicator roll and the maximum diameter of the embossing roll including the thickness of the web as measured according to EN 12625-3 so that the adhesive applicator roll transfers the adhesive to the embossed web corresponding to the protrusions of the embossing roll.

Recently, adhesive transfer rolls have become known having defined pit-shaped depressions in their circumferential surface. Such adhesive transfer rolls are known as anilox-rolls. Such roll is usually made of ceramic material or it is a roll made of steel or copper and coated with chromium. Excessive adhesive is removed from the surface of the anilox-roll by means of a blade. The amount of adhesive is determined by the volume and the number of depressions.

Alternative application systems for applying adhesives are based on a spraying equipment (e.g. Weko-technique).

A second possibility to influence the amount of adhesive transferred is the adjustment of the difference in circumferential speeds of the adhesive transfer roll and the applicator roll. Typically, the adhesive transfer roll rotates slower than the applicator roll. The circumferential speed of the adhesive transfer roll is usually between 5% and 100% of the first circumferential speed of the applicator roll. The adhesive bath can be designed as a simple trough, application systems with a blade can also be designed as chamber systems.

The embossing technologies Goffra Incolla/spot embossing and DESL/Nested, both use an additional roll, the so-called marrying roll for laminating together the plies. The marrying roll commonly has a smooth rubber surface with a hardness of 90-95 Shore A. A suitable material is e.g. NBR (acrylnitrile-butadien rubber) which is commonly used for tissue converting.

In case that the single layers individually or together are pre-embossed, a so-called pre-embosser is used. Very common is the use of a micro-pre-embossing device. Such a pre-embossing device is often used in combination with the Goffra Incolla technology. Also commonly used is printing onto the tissue product before or after the ply bonding step. Also known are variants including the application of chemical substances, especially lotions and softeners.

Instead of pre-embossing the top ply or plies in a pre-embossing unit, the pre-embossing can be done with the Goffra Incolla unit by using a so-called double height embossing roll.

Such situation is schematically shown in FIGS. 6 and 7 representing prior art.

FIG. 6 schematically shows the cross-section of the nip between an embossing roll 10 and an adhesive applicator roll 12. FIG. 7 schematically shows the nip between the embossing roll 10 and a conventional marrying roll 30. The embossing roll 10 as shown in FIGS. 6 and 7 has first embossing protrusions 16 having a first height and second embossing protrusions 18 having a second height which is smaller than the first height. Throughout the description, height in the context of protrusions on an embossing roll relates to the degree of radial projection of an embossing protrusion. The relative height of the embossing protrusions is not decisive. It is important that the maximum heights of the second embossing protrusions is less than the height of the first embossing protrusions, no matter whether or not the first and second embossing protrusions all start from a common fictitious circumferential surface of the embossing roll. Further, in FIGS. 6 and 7, the embossed first ply 20 is shown which substantially follows the shape of the embossing protrusions on the embossing roll 10.

As shown in FIG. 6, a conventional glue applicator roll 12 is used which typically has a hardness of 80 Shore A and serves to apply adhesive 22 to the top surfaces of the first embossing protrusions 16 only. As typical example, the first embossing protrusion 16 have a common height, whereas the second embossing protrusion have a height which is 0.4 mm less than that of the first embossing protrusions 16.

FIG. 7 shows the next process step in which, after adhesive 22 has been applied as shown in FIG. 6, a second ply 24 is bonded to first top ply 20 in the nip between the embossing roll 10 and a marrying roll 30. The marrying roll 30 typically has a high hardness of around 95 Shore A and the first ply is adhesively bonded to the second ply at the tops of the first embossing protrusions 16 which form embossed depressions in the surface of the first ply. The embossed depressions of the first ply extend inside the multi-ply product and in contact to the second ply where first ply and second ply 24 are adhesively bonded together.

A very similar situation is also known with regard to a triple or multi-height embossing system. Such a triple height embossing system is schematically shown in FIGS. 8 and 9 also relating to the prior art. The basic difference to the situation as already shown and explained with regard to FIGS. 6 and 7 is the shape of the embossing roll 10 having first embossing protrusions 16, second embossing protrusions 18 and, in additional to this, third embossing protrusions 19. Again, the embossed first ply 20 has already been embossed in the nip between the triple embossing roll and an anvil roll so that it substantially follows the shape of the embossing roll 10. In FIG. 8, the nip between the embossing roll and the adhesive applicator roll 12 is schematically shown. The situation is identical to that as explained above with reference to FIG. 6. Adhesive 22 is applied to the embossed first ply where it is arranged over the first embossing protrusions 16 of the embossing roll 10, whereas, due to the hardness of the glue application roll 12 and the dimension of the nip between the application roll 12 and the first embossing protrusions 16 of the embossing roll 10, adhesive 22 is not applied to other parts of the embossed first ply.

Typical heights relative to that of the first height of the first embossing protrusions for triple height embossing rolls are a second height of the second embossing protrusions which is 0.4 mm smaller than the first height and a third height which is 0.7 mm smaller than the first height. Thus, the first height serves as a kind of reference and the second height and third height are defined by the amount to which they are smaller than the first height. The other typical parameters like the hardness of the adhesive application roll and the marrying roll are the same as for the above prior art examples with a double height embossing roll.

As shown in FIG. 9, second ply 24 is bonded to the embossed first ply 20 in those regions where adhesive 22 has been applied which is where the first embossing protrusions formed the deepest depressions in the top ply 20.

In order to increase the visual effects of the embossed patterns, it is known in the art to use coloured adhesive which, in addition to the technical effects of embossing protrusions e.g. to increase the bulk of the product, can be used to improve the optical appearance. Nevertheless, the above described technologies are limited to one colour or one tone only.

When it is desired to manufacture two-coloured or multi-coloured products, it is known from EP 1 609 589 A2 to print onto the tissue product by using a coloured pre-embossing technology. The paper product disclosed therein is composed of two or more plies. A product is provided wherein a first ply has a first background embossing comprising first protuberances with a first height and a second decorative embossing comprising second protuberances with a second height. The first background embossing provides the technical-functional characteristics of the product and no glue must be applied thereto. The protuberances of the second decorating embossing can be of a different height to obtain specific technical functional effects. At least to some of the second protuberances, a glue is applied. To obtain a three-dimensional effect, specific positioning of shadings can additionally be made or more than one colour can be used.

### PRIOR ART

DE 10 2005 055 707 A1 describes a method for producing an at least four-ply tissue product. At least some protrusions of a first web are at least partially provided with an adhesive. The embossing unit consists of two micro-embossed rolls and one decor roll with embossing protrusions, which are higher than those of the micro-embossed protrusions. According to an embodiment, two different adhesive application rolls can be used, one for the combining of the two micro-embossed multi-layers and a second one for the decor embossing. The second adhesive applicator might also apply adhesive to the whole surface of the web.

US 2005/0170145 A1 discloses an embossing geometry with a different height of the background pattern and the decor pattern. The plies are bonded together with adhesive which may be colored. The extremities of the protuberances produced in the ply by the background pattern of lesser height do not come into contact with the surface of the glueing roller and do not receive any adhesive. US 2005/0170145 A1 represents the closest prior art.

### SUMMARY OF THE INVENTION

It is the object of the invention to provide a product with at least two differently coloured tones which is easy to manufacture as well as a corresponding manufacturing process and device.

This object is solved by a method for producing a multi-ply fibrous product with the features of claim 1, a multi-ply fibrous product with the features of claim 9 and a device for producing a multi-ply fibrous product with the features of claim 18. Further preferred embodiments follow from the dependent claims.

According to the invention, a method for producing a multi-ply fibrous product, especially a tissue paper product, non-woven product or a hybrid thereof and preferably a hygiene or cleaning product, comprises the following method steps:
embossing at least one first ply, especially forming the top ply of a product in the nip between an embossing roll and an anvil roll; wherein
the embossing roll has embossed protrusions on its outer circumferential surface having at least two different radial heights, the embossed protrusions comprising first embossing protrusions with a first height and second embossing protrusions with a second height, the second embossing protrusions having a height being smaller than that of the first embossing protrusions;
applying coloured adhesive or coloured ink to the first ply where it is positioned over the first and second embossing protrusions by means of an adhesive application roll;
bonding together the at least one first ply and at least one second ply in the nip between the embossing roll and a marrying roll or between the embossing roll and a second embossing roll such that the ply bonding is generated between the at least one first ply and the at least one second ply only where the at least one first ply is positioned over the first embossing protrusions.

Embossing protrusions of the embossing roll translate into embossed depressions in the product, like depressed dots. Hence, the first ply forms first and second depressions where it is positioned over the first and second embossing protrusions of the embossing roll. Since the embossing roll has at least two different radial heights of the embossing protrusions, this translates into a corresponding shape of the first ply having at least two different depths of the embossing depressions formed in the nip between the embossing roll and the anvil roll. Due to a certain elasticity of the fibrous product, the shape of the embossing protrusions of the embossing roll will not fully correspond to the geometry of the embossed depressions in the first ply.

Ideally, the correlation between the inventive embossing roll and the fibrous product achieved from using such embossing roll in a device comprising such roll and a cooperating anvil roll leads to a mirror image of the fibrous product as compared to the inventive embossing roll. However, there is actually a loss which occurs in the production process. Such loss can be attributed to the fact that the fibrous product as processed is visco-elastic, i.e. during embossing, there is a certain part of the deformation which is elastic. Therefore, after the embossing step, there is some spring back behaviour of the fibrous product so that the geometry of the embossing roll does not generate an embossed product which is the mirror image of the roll. The degree of loss depends on the material of the fibrous product, the characteristics of the embossing roll and anvil roll and many other factors, but mainly depends on the geometry of the embossing pattern provided on the circumferential surface of the embossing roll. Usually, the shape of the product is less sharp and less in height compared to the shape of the embossing roll.

In the following, the term “embossing protrusions” will be used when describing the embossing roll and the term “embossed depressions” will be used when describing the first ply or plies of the inventive product and it will be assumed that the shape of the depressions corresponds to the shape of the protrusions.

The basic idea underlying the inventive method is to apply coloured adhesive towards both the first and second embossing protrusions and correspondingly towards the top surfaces of the first and second depressions of the top ply, whereas the marrying roll or further embossing roll only generates the ply bonding between the first depressions of the at least one first ply and the at least one second ply. Therefore, the applied adhesive is only partly used to generate ply bonding. This produces a visual effect of two different coloured tones without using an additional unit like a printing unit or a pre-embossing unit. More exactly, the technical solution as described above delivers the product with two different tones: a light one and a dark one. The visual effect appears because the amount of coloured adhesive transferred to the first ply at the second embossing protrusions is less than the adhesive transferred to the first ply at the first embossing protrusions. The reason for this effect is the limited elasticity of the adhesive applicator roll which applies the highest amount of adhesive to those parts of the first ply which come closest to the surface of the applicator roll. The more adhesive is applied to a certain part of the top ply, the darker is the colour tone associated therewith. A second reason for the existence of different tones is the bonding together of the first ply and the second ply at the first embossing protrusions of the marrying roll. This also leads to a darker colour tone compared to the other regions of the first ply to which adhesive colour has been applied but where no ply bonding has been affected. For products with at least two first plies, there can be a small spacing between the first plies at the second depressions. This also contributes to diminishing the visual appearance of the colour. A third reason for the smaller colour density at the second depressions is attributable to the lower penetration of the adhesive into the tissue or, in case of a plurality of first plies, through the plies at the second depressions. This is because the pressure exerted when applying adhesive by means of an applicator roll is less at the second embossed depressions compared to the first embossed depressions. A further reason for this lower penetration is the absence of the process step of marrying.

The fibrous product according to the invention is especially a tissue paper product, non-woven product or a hybrid thereof, and preferably a hygiene or cleaning product. It has at least one embossed first ply having first embossed depressions with a first depth and second embossed depressions with a second depth. The first depressions and second depressions have top surfaces which are being covered with coloured adhesive. The at least one first ply and the at least one second ply are bonded together only by means of the coloured adhesive applied to the top surfaces of the first embossed depressions.

The term non-woven according to ISO 9092, DIN EN 29092 is applied to a wide range of products which, in terms of their properties are located between those of paper (DIN 6730, May 1996) and cardboard (DIN 6730) on the one hand, and textiles on the other hand. As regards non-woven a large number of extremely varied production processes are used, such as the air-laid and spun-laced techniques as well as the wet-laid techniques. The non-wovens include mats, non-woven fabrics and finished products made thereof. Non-wovens may also be called textile-like composite materials, which represent flexible porous fabrics that are not produced via the classic methods of weaving warp and weft or by looping. In fact, non-wovens are produced by intertwining, cohesive or adhesive bonding of fibers, or a combination thereof. The non-woven material can be formed of natural fibers, such as cellulose or cotton fibers, but can also consist of synthetic fibers such as polyethylene (PE), polypropylene (PP), polyurethane (PU), polyester, fibers on the basis of polyethylenterephtalate, polyvinyl alcohol, nylon or regenerated cellulose or a mix of different fibers. The fibers may, for example, be present in the form of endless fibers or pre-fabricated fibers of a finite length, as synthetic fibers, or in the form of staple fibers. The non-wovens as mentioned herein may thus consist of mixtures of synthetic and cellulose fibrous material, e.g. natural vegetable fibers (see ISO 9092, DIN EN 29092).

The term “hygiene products” and “cleaning products” as used herein comprise bathroom tissue, household towels, handkerchiefs, facial tissues, napkins, wiping and cleaning products as well table ware. It does not comprise wall paper products.

The inventive device for producing a multi-ply fibrous product comprises an embossing roll comprising embossing protrusions on its circumferential surface having at least two different heights in a radial direction, an anvil roll cooperating with the embossing roll, an application roll preferably adhesive application roll arranged next to the embossing roll, and a marrying roll or another embossing roll running against the embossing roll. The adhesive application roll forms a negative gap with the outer diameter of the embossing roll, preferably in a range of 0.6 mm to 1.0 mm and most preferably around 0.8 mm.

By using a so-called negative gap (German: Beistellung), it is possible also to reach the second embossing protrusions with the adhesive application roll. The term “negative gap” describes the situation, in which, the outer circumferential surface of the adhesive application roll extends into the hypothetical cylinder defined by circumscribing the first embossing protrusions of the embossing roll. Such a positioning is only possible if the adhesive application roll has a sufficient flexibility to become elastically deformed by the first and possibly second embossing protrusions of the embossing roll. Usually, the embossing roll is made of metal, especially steel, or hard plastics material or hard rubber. In case of plastics, a very hard plastics material is preferred, alternatively a resin material is also possible. Therefore, it is the adhesive application roll which has to provide the sufficient elasticity. It should be mentioned that the preferred hardness of the application roll is somewhat smaller (about 5 to 10 Shore A) than in the prior art, but still higher than that of the anvil roll.

According to a preferred embodiment of the inventive method, the second ply/plies is/are pre-embossed with a micro-embossing patterns before directing the second ply into the nip between the embossing roll and the marrying roll. Such pre-embossing step mainly serves to produce micro Depressions leading to a background pattern on the second ply or plies of the multi-ply fibrous product. Micro embossing elements have a density of more than 20/cm², whereas embossing elements arranged in a density of less than 20/cm² are defined as a macro pattern.

According to a preferred embodiment, the first ply is embossed such that it comprises third embossed depressions having a depth which is smaller than the depths of the first embossed depressions and the second embossed depressions. This is produced by means of a triple height embossing roll as known in the prior art and described with reference to FIGS. 8 and 9.

When using a triple height embossing of the first ply, it is possible to apply the adhesive to the first, second and third embossed depressions of the first ply. The decision to which extent the embossed depressions should be covered with coloured adhesive depends on the desired visual effect and the characteristics of the product. The more adhesive is applied, the stiffer the resulting product becomes even if only part of the depressions are finally used to achieve ply bonding. A further fact of influence is the type of adhesive used in this process. For laminating together the single webs of material, different types of adhesive can be used. Suitable adhesives are, inter alia, glue on the basis of starch or modified starch like for example methyl cellulose or carboxylized methyl cellulose and adhesively acting polymers on the basis of synthetic resins, caoutchouc, polypropylene, polyisobutylene, polyurethane, polyacrylates, polyvinylacetat or polyvinyl alcohol. Such adhesives can also contain dyes and/or pigments in order to improve the optical appearance of the finished products. In case of the use of pigments, disperging agents as well as binding agents are additionally used as is common in the art. Frequently, water based glues are used for laminating together paper layers. Further, additives like fastener, retarding agents, anti-foaming agents or degassing agents can be used.

According to a preferred embodiment, when the first ply/plies is/are embossed using a triple height embossing roll, the coloured adhesive is applied to the first embossed depressions and second embossed depressions, whereas the third embossed depressions having the lowest depths do not receive coloured adhesive. Alternatively and as outlined above, the third embossed depressions can receive adhesive as well. This leads to three different colour tones because the highest level at the first depressions appears darkest as was explained above. The second level corresponding to the second depressions appears lighter in colour than the first/highest level but darker than the third level corresponding to the third depressions. This is mainly because more glue is applied to the second level compared to the third level so that different colour tones leading to a different visual impression can be created with up to three different colour tones.

Preferably, the inventive method further comprises the step of directing at least one further ply into the nip between the embossing roll and the adhesive application roll, the further ply being sandwiched between the first ply and the second ply. According to a preferred embodiment, the at least one third ply is volume embossed before it is introduced into the nip between the adhesive application roll and the embossing roll. The technique of volume embossing of conventional products is known from WO2002/103112, the teaching of which is incorporated herein by reference. A volume embossed middle ply serves to impart a high volume to the product and might be useful if a product with the feeling of a high volume is desired.

Alternatively, it is also possible to emboss the at least one third ply together with a first ply or second ply.

As regards the temperature at which the process is carried out, it is possible either to use room temperature or using heat embossing. The use of heat embossing technique serves to realize geometries which are complex, and therefore, difficult to realize for a given fibrous product especially for non-woven products or hybrid products. In other words, the application of heat might be beneficial to realize highly complex embossing geometries in the inventive product. Further, heat embossing may increase the stability of the embossed geometry.

According to a preferred embodiment of the inventive multi-ply fibrous product, the at least one first ply further comprises first embossed depressions which have an elongate shape. Such depressions are formed by means of embossing protrusions of the embossing roll which are elongate rips, the width and height of which can change continuously in a longitudinal direction of the rip. The provision of such elongate embossed depressions serve to increase the variability of possible embossed shapes and the colour tones of the embossed pattern of the inventive product.

Preferably, the difference between the depths of the first embossed depressions and the depths of the second embossed depressions is less than 0.4 mm, preferably about 0.2 mm. This is less than the standard difference in heights between the first and second embossing protrusions as discussed above with reference to FIG. 6. A smaller difference in the depths of the embossed depressions has the disadvantage that the visibility of the different types of embossing patterns becomes less significant. Nevertheless, it is advantageous to provide a difference being less than 0.4 mm so that an adhesive application roll still conveys a sufficient amount of adhesive to the second embossed depressions which increases the visibility of the second embossed depressions.

According to a preferred embodiment of the invention, the fibrous product further comprises at least one middle ply which is preferably volume embossed. Thus, the product can comprise several middle plies leading to e.g. a 4-ply, 5-ply or 6-ply product.

In order to provide further visual effects, at least one ply can be made of a coloured base web. Especially and preferably, the middle ply of a three-ply or multi-ply fibrous product can be made of a coloured base web. If the plies are combined, the colour of the coloured ply shines through the top ply. Especially in case that the product is wound up onto a roll, a backside ply shining through the top ply can provide an additional interesting effect also adding a different colour. Alternatively, a middle ply can be made of a coloured base web and shines through both sides of the product. This can be used to achieve a very light coloured background.

If the colour of the glue and the colour of the plies are similar, tone in tone designs can be created with different tones. For example, the base plies could be light green and an adhesive having a dark green colour could be used resulting in different tones of dark green embossing on a light green background.

According to a preferred embodiment of the inventive device, the adhesive application roll has a hardness of less then 80 Shore A. In common practice, such adhesive application rolls have a hardness which is higher, but in the specific case where adhesive should also be applied to embossed depressions having a smaller depth than the so-called first embossed depressions, an adhesive application roll with a high elasticity and spring back characteristics is needed.

Preferably, the marrying roll has a hardness of more than 95 Shore A. In other words, it is preferred that the marrying roll is harder than marrying rolls usually are. This serves to increase the effect that although adhesive has been applied to the first and second depressions of the first ply, ply bonding is only achieved between the first depressions of the first ply and the second ply or middle ply. To this end, the marrying roll preferably comprises a steel band wrapped around its circumferential surface covering at least 5% of the circumferential surface and preferably at least 90% of the circumferential surface. The steel band spirally wound around the circumferential surface contributes to a high surface hardness of the marrying roll of more than 95 Shore A.

According to a preferred embodiment, the anvil roll is made of rubber, like EPDM or NBR, paper or steel. Such materials are known in the art for providing an elasticity which is high enough so that the first ply to be embossed follows the embossing pattern of the steel embossing roll as closely as possible.

According to a preferred embodiment, the inventive device further comprises a pre-embossing device for at least one further ply. Such a pre-embossing device is used to provide a micro-embossing pattern to the at least one further ply. A micro embossing pattern is often a relatively regular pattern of densely arranged small embossed protrusions. A density of embossed elements of more than 20/cm² is defined herein as a micro embossing pattern. Such a micro embossing pattern can be selected freely based on functional criteria in order to give the paper product certain characteristics in term of overall strength, bulk or smoothness. Optical requirements and effects do not play a major roll when selecting a suitable micro embossing pattern.

### BRIEF DESCRIPTION OF THE DRAWINGS

FIG. 1 schematically shows the relevant part of the inventive converting device;

FIG. 2 schematically shows the nip between a double height embossing roll and an adhesive application roll according to the invention;

FIG. 3 schematically shows the nip between a double height embossing roll and a marrying roll according to the invention;

FIG. 4 schematically shows the nip between a triple height embossing roll and an adhesive application roll according to the invention;

FIG. 5 schematically shows the nip between a triple height embossing roll and a marrying roll according to the invention;

FIG. 6 schematically shows the nip between a double height embossing roll and an adhesive application roll according to the prior art;

FIG. 7 schematically shows the nip between a double height embossing roll and a marrying roll according to the prior art;

FIG. 8 schematically shows the nip between a triple height embossing roll and an adhesive application roll according to the prior art;

FIG. 9 schematically shows the nip between a triple height embossing roll and a marrying roll according to the prior art.

### DESCRIPTION OF PREFERRED EMBODIMENTS

Throughout the drawings, the same elements are denominated by the same reference numerals. Unless otherwise described, general information and explanations with regard to preceding embodiments also apply to subsequent embodiments.

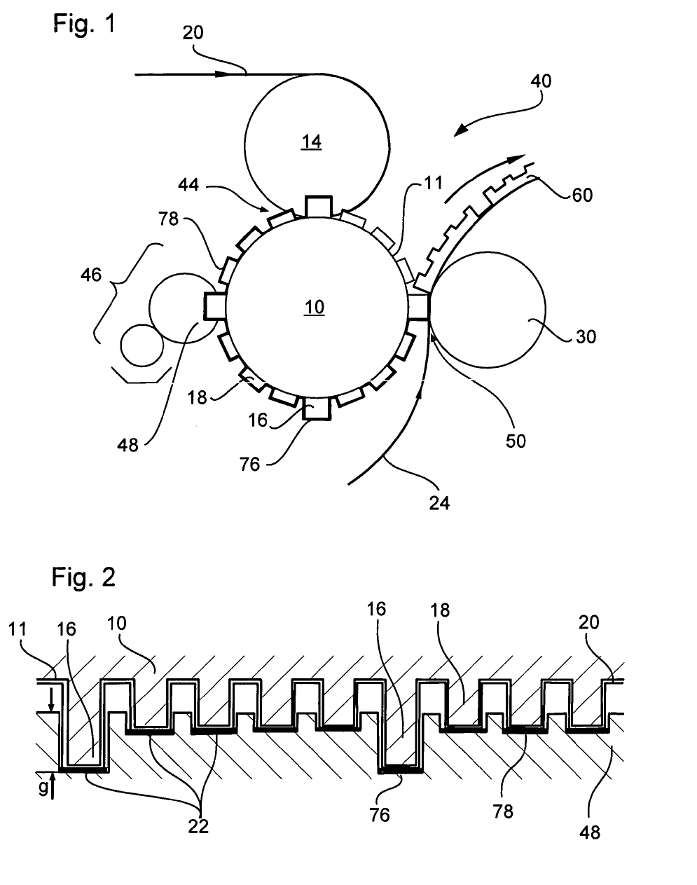

In FIG. 1, the essential part of an inventive paper converting device is shown. The device, generally given with reference numeral 40 consists of an embossing roll 10 which is preferably made of steel, very hard plastics, a resin or a hard rubber. The embossing roll 10 has a male embossing geometry. There are embossing protrusions which extend to at least two different radial heights. These are first embossing protrusions 16 and second embossing protrusions 18, the first embossing protrusions 16 having a greater height (radial extension) than the second embossing protrusions 18. The steel embossing roll 10 cooperates with an anvil roll 14 preferably made of rubber, like EPDM or NBR. Alternatively, anvil rolls made of paper or steel are also possible. The anvil roll 14 usually has a hardness between 35 Shore A and 60 Shore A providing a high elasticity.

The first ply 20, usually but not necessarily forming the top ply of a finished product 60, runs through the nip 44 between the anvil roll 14 and the embossing roll 10 where the first ply 20 receives an embossing pattern which is nearly a mirror image to the embossing protrusions on the outer surface of the embossing roll. In the present case, the embossing protrusions of the embossing roll provide embossed depressions in the first ply 20. After having been embossed, the first ply 20 runs together with the rotating steel embossing roll 10 to an adhesive application unit 46 comprising an adhesive application roll 48. The adhesive application roll 46 receives coloured adhesive from one or more transport rolls and transfers it to the first ply 20 in those regions where embossed depressions 76, 78 snuggly fit over embossing protrusions of the steel embossing roll.

The adhesive application roll has a hardness of less than 80 Shore A and is positioned such that it form a negative gap relative to the steel embossing roll. Therefore, the adhesive on the adhesive application roll 48 is not only applied to those parts of the first ply which are positioned over the first embossing protrusions 16 of the steel embossing roll, but also applied to those parts of the first ply which are positioned over the second embossing protrusions 18 of the steel embossing roll. After adhesive has been applied, the first ply runs with the rotating embossing roll 10 to the third nip 50 between the embossing roll 10 and a marrying roll 30. Into this nip 50, the second ply 24 forming the bottom ply in the finished product 60 according to this specific example is introduced and ply bonded to the first ply 20. Specifically, the first ply 20 and the second ply 24 are only bonded together in those parts, where the first ply 20 is positioned over the first embossing protrusions 16 of the embossing roll 10. In order to achieve this desired effect, care has to be taken that the marrying roll 30 does not inadvertently provide a significant ply bonding between the first ply 20 and second ply 24 in those parts of the first ply 20 which are positioned over the second embossing protrusions 18. Therefore, the marrying roll 14 has a very high hardness of more than 95 Shore A. Alternatively, a so-called futura marrying roll with a steel band spirally wound around the outer circumferential surface of the rubber-coated marrying roll can also be used. After leaving the third nip 50 of the device, the finished multi-ply product 60 can be directed to further processing steps.

Alternative measures like the provision of an additional embossing to the second ply 24 or the adding of one or more middle plies which become sandwiched between the first ply 20 and the second ply 24 are not shown in the schematic drawing of FIG. 1 which only concentrates on the key components of the invention.

The relative positioning of the adhesive application roll 48 and of the marrying roll 30 relative to the embossing roll as well as the selection of suitable materials for the adhesive application roll 48 and the marrying roll 30 provide, when using coloured adhesive, the desired effect of a multi-tone optical appearance without the need for additional components.

In order to achieve the effect as described above, it is recommended to provide a reference height of the first embossing protrusions and a height of the second embossing protrusions which is about 0.3 mm smaller than the reference height (first embossing height). The difference between the first embossing height and the second embossing height is 0.3 mm only, which is smaller than usual. The glue application roll should have a negative gap of around 0.5 mm relative to the steel embossing roll so that the coloured adhesive can also reach the first ply where it is positioned over the second embossing protrusions of the embossing roll.

FIG. 2 schematically shows the nip between a double height embossing roll 10 and the adhesive application roll 48. In addition to this, the embossed first ply 20 is schematically shown as being positioned over the surface of the embossing roll 10. Starting from the base circumferential surface 11 of the embossing roll, there are first embossing protrusions 16 and second embossing protrusions 18. The adhesive application roll 48 is positioned such that it forms a negative gap g relative to the circumferential surface of the embossing roll 10 defined by the first embossing protrusions. Therefore, the adhesive application roll is elastically depressed in those regions where the first embossing protrusions 16 and the second embossing protrusions 18 are positioned. Therefore, adhesive 22 is not only applied to the first ply 20 in those regions where embossed depressions 76 are formed over the first embossing protrusions 16 but also in those regions where second embossed depressions 78 are formed over the second embossing protrusions 18.

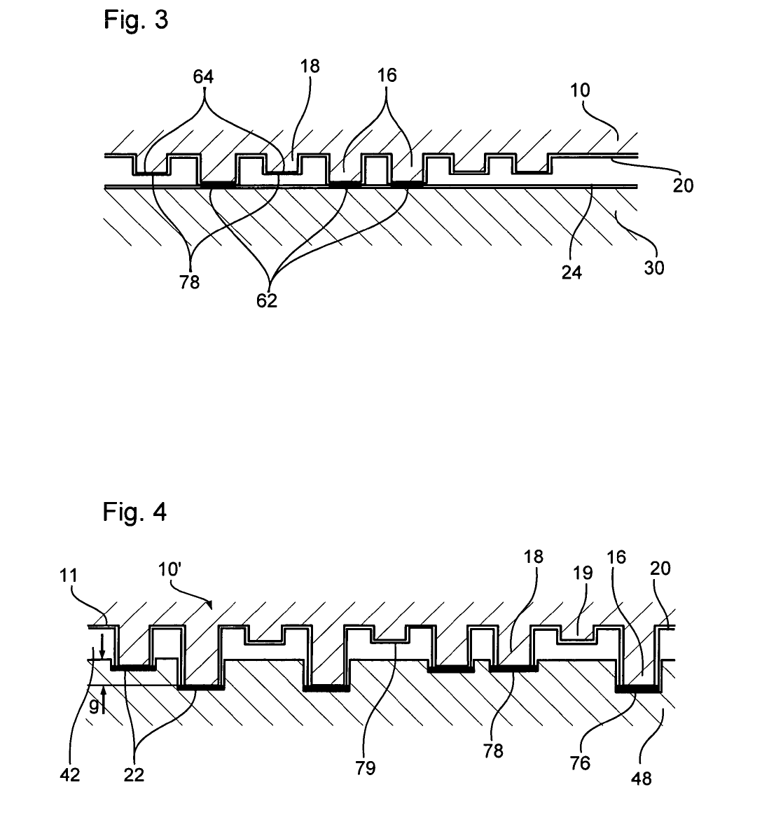

FIG. 3 schematically shows a nip between the double height embossing roll 10 and the marrying roll 30. Additionally, a second ply 24 which is schematically shown as being micro-embossed and the embossed first ply 20 are shown. Again, the embossing roll 10 has first embossing protrusions 16 and second embossing protrusions 18. The marrying roll 30 has a much higher hardness than the adhesive application roll as shown in FIG. 2. Further, there is a minor negative gap between the embossing roll and the anvil roll. Therefore, ply bonding is only achieved in the regions as marked by reference numerals 62, whereas in the regions 64 where the first ply 20 forms second embossed depressions 78 over the second embossing protrusions 18 of the embossing roll is coloured by the coloured adhesive but not bonded to the second ply 24. In view of the fact that regions 64 receive less adhesive compared to regions 62 and, in addition to this, regions 62 are bonded to the second ply, regions 62 are more strongly coloured than regions 64 being only light coloured. Therefore, despite of the fact that no additional manufacturing step was used, a product with two front colour tones can be provided.

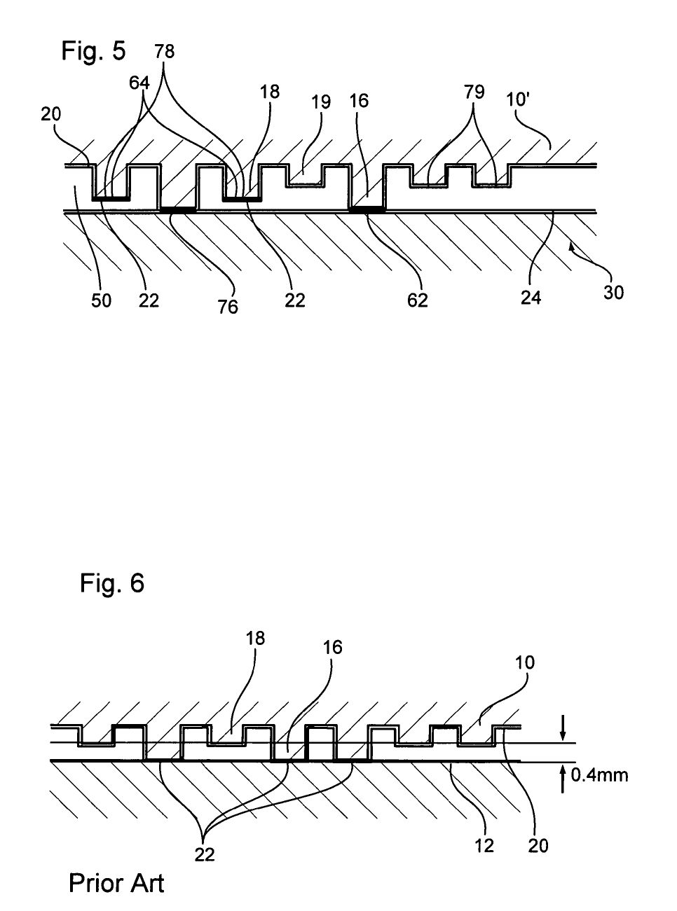

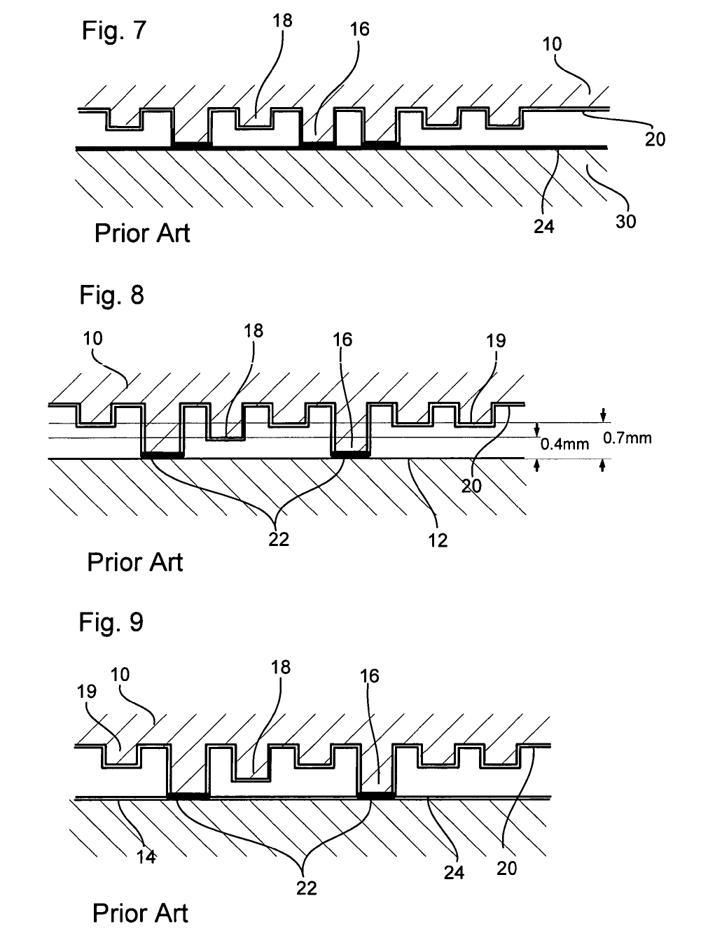

FIGS. 4 and 5 correspond to FIGS. 2 and 3 but, additionally show the situation using a triple height embossing roll 10′. In FIG. 4, the nip 42 between the embossing roll 10′ and the adhesive application roll 48 is shown. The embossing roll has first embossing protrusions 16, second embossing protrusions 18 and third embossing protrusions 19. As can be seen from FIG. 4, the first embossing protrusions 16 have the highest height being the reference height, the second embossing protrusions 18 have a lower height and the additional third embossing protrusions 19 have the lowest height. The embossed first ply 20 having been embossed between the triple height embossing roll 10′ and a suitable anvil roll has first embossed depressions 76, second embossed depressions 78 and third embossed depressions 79 substantially following the shape of the corresponding embossing protrusions of the embossing roll 10′. The adhesive application roll 48 is positioned such that the negative gap g is large enough to apply adhesive 22 not only to the first ply positioned over the first embossing protrusions 16 (first embossed depressions 76), but also the second embossing protrusions 18 (second embossed depressions 78). However, the negative gap g and/or elasticity of the adhesive application roll 48 is not sufficient to apply adhesive to the first ply where third embossing depressions 79 were formed by the third embossing protrusions 19.

FIG. 5 corresponding to FIG. 3 but for the triple height embossing roll 10′ again shows the regions 62 where a ply bonding is achieved and where, due to the maximum amount of adhesive transferred and the additional ply bonding between the first ply 20 and the second ply 24, a dark colour tone is achieved. Further the regions 64 are shown where second embossing depressions 78 of the first ply 20 are formed over the second embossing protrusions 18 of the embossing roll 10′. In these regions, adhesive 22 has been applied but no ply bonding takes place so that a light colour tone is achieved.

For the above example using a triple height embossing roll 10′, the following parameters could be used as an example. Based on the heights of the first embossing protrusions 16 as a reference, the heights of the second embossing protrusions 18 are around 0.3 mm smaller than the height of the first embossing protrusions 16. The height of the third embossing protrusions 19 is around 0.9 mm smaller that the height of the first embossing protrusions 16. The negative gap g of the adhesive application roll is around 0.8 mm. The adhesive application roll has a hardness of less than 80 Shore A, whereas the marrying roll should have a hardness of more than 95 Shore A.

The advantages of the inventive process, device and product over the prior art are to achieve a colour embossing with at least two tones without additional process steps or devices. If additionally coloured base material is used, for example coloured base tissue, a product with three coloured tones can be manufactured.

If all embossing elements which should be coloured would be on the same embossing level, there would be a lot of bonding points which would lead to a product which could be perceived as being stiff. According to the invention as described above, a softer product can be achieved still providing a visual appealing appearance and even different colour tones. No additional printing equipment or additional pre-embossing unit together with a colour application unit is needed.

1-25. (canceled)

26. Method for producing a multi-ply fibrous product selected from the group consisting of a tissue paper product, a non-woven product and a hybrid thereof, which comprises the following steps:
(a) embossing at least one first ply forming the top ply of a product in nip between an embossing roll and an anvil roll; wherein the embossing roll has protrusions on its outer circumferential surface having at least two different radial heights, the embossing protrusions comprising first embossing protrusions with a first height and second embossing protrusions with a second height, the second embossing protrusions having a height being smaller than that of the first embossing protrusions;
(b) applying colored adhesive or ink to the first ply where it is positioned over the first and second embossing protrusions via an application roll; and
(c) bonding together said at least one first ply and at least one second ply in a nip between the embossing roll and a marrying roll or between the embossing roll and a second embossing roll such that the ply bonding is generated between said at least one first ply and said at least one second ply only at those portions where said at least one first ply is positioned over the first embossing protrusions of the embossing roll.

27. The method according to claim 26, wherein the at least one second ply is pre-embossed with a micro-embossing pattern before directing it into the nip between the embossing roll and the marrying roll.

28. The method according to claim 26, wherein the at least one first ply is embossed such that it comprises third embossed depressions having a depth which is smaller than the depth of the first embossing depressions and the second embossing depressions.

29. The method according to claim 28, wherein in step (b) the adhesive (22) is applied to the first, second and third embossing depressions.

30. The method according to claim 28, wherein in step (b), colored adhesive is applied to the first embossing depressions and to the second embossing depressions.

31. The method according to claim 26, further comprising a step (b2) of directing at least one further ply into the nip between the embossing roll and the adhesive application roll between the first ply and the second ply.

32. The method according to claim 31, wherein before step (b2), the at least one further ply is volume embossed.

33. The method according to claim 26, wherein in step (b) there is a negative gap between the first protrusions of the embossing roll and the application roll, and the gap is adjusted such that its dimensions exceeds that of the difference in heights between the first embossing protrusions and the second embossing protrusions.

34. Multi-ply fibrous product selected from the group consisting of a tissue paper product, a non-woven product and a hybrid thereof, comprising:
at least one embossed first ply having first embossed depressions with a first depth and second embossed depressions with a second depth;
the first embossed depressions and the second embossed depressions having a top surface and being covered with colored adhesive or ink;
the at least one first ply and at last one second ply being bonded together only at the top surfaces of the first embossed depressions.

35. The multi-ply fibrous product according to claim 34, wherein the product has two different tones formed by the colored adhesive or ink, a dark tone at the first embossed depressions and a lighter tone at the second embossed depressions.

36. The multi-ply fibrous product according to claim 34, wherein the color density of the colored adhesive or ink at the second embossed depressions is smaller than the colour density of the first embossed depressions.

37. The multi-ply fibrous product according to claim 34, wherein the at least one first ply further comprises first embossed depressions which have an elongate shape.

38. The multi-ply fibrous product according to claim 34, wherein the difference between the depths of the first embossed depressions and the depths of the second embossed depressions is less than 0.4 mm.

39. The multi-ply fibrous product according to claim 34, wherein the first ply further comprises third embossed depressions having a third depth smaller than the first depth and smaller than the second depth; the top surfaces of the third embossed depressions not being covered with colored adhesive (22).

40. The multi-ply fibrous product according to claim 39, wherein the first ply and the second ply are bonded together with colored adhesive at the top surfaces of the first embossed depressions.

41. The multi-ply fibrous product according to claim 34, further comprising at least one middle ply which is volume embossed.

42. The multi-ply fibrous product according claim 34, wherein at least one ply is made of a colored base web.

43. Device for producing a multi-ply fibrous product according to claim 34, comprising:
an embossing roll comprising first and second embossing protrusions on its outer circumferential surface having at least two different heights in a radial direction;
an anvil roll cooperating with the embossing roll;
an application roll for applying colored adhesive or ink arranged next to the embossing roll; and
a marrying roll or another embossing roll running against the embossing roll; wherein
the application roll forms a negative gap with the outer diameter of the embossing roll, and the negative gap exceeds the difference in height of the first and second protrusions.

44. The device according to claim 43, wherein the negative gap between the outer diameter of the embossing roll is in the range of 0.6 mm to 1.0 mm.

45. The device according to claim 43, wherein the application roll has a hardness of less than 80 Shore A.

46. The device according to claim 43, wherein the difference in height between the two different heights is less than 0.4 mm.

47. The device according to claim 43, wherein the marrying roll has a hardness of more than 95 Shore A.

48. The device according claim 43, wherein the marrying roll comprises a steel band wrapped around its circumferential surface covering at least 5% of the circumferential surface.

49. The device according to claim 43, wherein the anvil roll is made of rubber, paper or steel.

50. The device according to claim 43, further comprising a pre-embossing device for at least one further ply.
